(19) United States
(12) Patent Application Publication
(10) Pub. No.: US 2026/0103182 A1
(43) Pub. Date: Apr. 16, 2026

(54) HYBRID ELECTRIC VEHICLE AND METHOD OF CONTROLLING THE SAME

(71) Applicants: HYUNDAI MOTOR COMPANY, SEOUL (KR); KIA CORPORATION, SEOUL (KR)

(72) Inventors: Jae Ho Hwang, Hwaseong-si (KR); Hong Geuk Park, Hwaseong-si (KR); Min Kim, Hwaseong-si (KR); Sang Hun Han, Hwaseong-si (KR); Tae Young Chung, Hwaseong-si (KR); Jung Hwi Kim, Hwaseong-si (KR)

(73) Assignees: HYUNDAI MOTOR COMPANY, SEOUL (KR); KIA CORPORATION, SEOUL (KR)

(21) Appl. No.: 19/047,180

(22) Filed: Feb. 6, 2025

(30) Foreign Application Priority Data
Oct. 11, 2024 (KR) 10-2024-0138832

(51) Int. Cl. B60W 20/17; B60W 10/06; B60W 10/08; B60W 30/20

(52) U.S. Cl. CPC B60W 20/17; B60W 10/06; B60W 10/08; B60W 2030/206; B60W 2510/0657; B60W 2710/083

(57) ABSTRACT

A hybrid electric vehicle includes an engine, a first motor including a driving shaft connected directly to the engine, and a controller configured to identify vibration of the engine through the first motor in a mode where the first motor performs charging with power of the engine, identify compensation torque, which periodically increases and decreases to have a reverse phase to the vibration, identify final compensation torque, and control output torque of the first motor based on a sum of the final compensation torque and the charging torque, thereby reducing vibration and noise due to the engine exciting force of the hybrid electric vehicle, and effectively reducing the vibration in a low frequency band due to torque imbalance.

### CROSS REFERENCE TO RELATED APPLICATIONS

The present application claims priority to Korean Patent Application No. 10-2024-0138832, filed Oct. 11, 2024, the entire contents of which is incorporated herein for all purposes by this reference.

### BACKGROUND

### Field Of The Disclosure

The disclosure relates to a hybrid electric vehicle, in which vibration due to the exciting force of an engine is reduced, and a method of controlling the same.

### Description of the Related Art

With recent increasing interest in environment, eco-friendly vehicles using an electric motor as a driving source have been increasing. The eco-friendly vehicle is also referred to as an electrified vehicle, representative examples of which includes hybrid vehicles (HEV) or electric vehicles (EV).

The hybrid electric vehicle generally includes an internal combustion engine and an electric motor, and the engine of the hybrid electric vehicle is usually turned off while the vehicle is stopped. However, when a battery needs to be charged, stationary charging (or charging while being stopped) may be performed by operating the engine even while the vehicle is stopped and charging the battery of the hybrid electric vehicle with power generated by the motor. In this case, vibration and noise due to the exciting force of the engine may be transmitted to the inside of the vehicle, and the vibration and the noise may reduce a passenger's satisfaction.

The foregoing matters described as the related art are only for enhancing the understanding of the background of the disclosure and should not be taken as an acknowledgement that they are the prior art already known to a person having ordinary skill in the art.

### SUMMARY

The disclosure provides a hybrid electric vehicle, in which vibration and noise due to the exciting force of an engine are reduced, and a method of controlling the same.

Further, the disclosure provides a hybrid electric vehicle, in which vibration in a low frequency band due to torque imbalance is effectively reduced in the process of reducing vibration and noise, and a method of controlling the same.

Further, the disclosure provides a hybrid electric vehicle, in which reduction in charging torque is minimized, and a method of controlling the same.

It should be noted that aspects of the disclosure are not limited to the above-mentioned aspect, and other aspects of the disclosure will be apparent to those skilled in the art from the following descriptions.

According to an embodiment of the disclosure, a hybrid electric vehicle includes an engine, a first motor including a driving shaft connected directly to the engine, and a controller configured to identify vibration of the engine through the first motor in a mode where the first motor performs charging with power of the engine, and identify compensation torque, which periodically repeats increase and decrease to have a reverse phase to the vibration, identify final compensation torque, in which an absolute value of the compensation torque is limited not to exceed a value obtained by subtracting changing torque of the first motor from maximum torque of the first motor when a sum of a maximum amplitude of the compensation torque and a magnitude of the charging torque exceeds the maximum torque, and control output torque of the first motor based on a sum of the final compensation torque and the charging torque.

According to an embodiment, the controller may be configured to identify the vibration by extracting a vibration component of a cycle corresponding to two rotations of the first motor.

According to an embodiment, an amplitude of the compensation torque may be identified based on a torque map previously set according to revolutions per minute (RPM) of the driving shaft.

According to an embodiment, a phase of the compensation torque may be identified by substituting the RPM of the driving shaft into an adaptive filter.

According to an embodiment, the controller may be configured to identify the phase of the compensation torque again when the vibration identified after controlling the output torque has a greater magnitude than a preset reference vibration.

According to an embodiment, the controller may be configured to identify the compensation torque in a sinusoidal waveform.

According to an embodiment, the hybrid electric vehicle may further include a second motor connected directly to an input terminal of a transmission, and an engine clutch configured to selectively connect the first motor and the second motor.

According to an embodiment of the disclosure, hybrid electric vehicle includes an engine, a first motor including a driving shaft connected directly to the engine, and a controller configured to identify vibration of the engine through the first motor in a mode where the first motor performs charging with power of the engine, and identify compensation torque, which periodically repeats increase and decrease to have a reverse phase to the vibration, limit maximum and minimum values of the compensation torque to a first value and a second value having an opposite sign to the first value, respectively, when a sum of a maximum amplitude of the compensation torque and the charging torque exceeds a maximum torque of the first motor, and control output torque of the first motor based on a sum of the limited compensation torque and the charging torque, wherein the first value corresponds to a value obtained by subtracting the changing torque from the maximum torque.

According to an embodiment of the disclosure, a method of controlling a hybrid electric vehicle, including by a controller, identifying vibration of an engine, which is directly connected to a driving shaft of a first motor, through the first motor, identifying compensation torque, which periodically repeats increase and decrease to have a reverse phase to the vibration, identifying final compensation torque, in which an absolute value of the compensation torque is limited not to exceed a value obtained by subtracting changing torque of the first motor from maximum torque of the first motor when a sum of a maximum amplitude of the compensation torque and a magnitude of the charging torque exceeds the maximum torque; and controlling output torque of the first motor based on a sum of the final compensation torque and the charging torque.

According to an embodiment, the vibration may be identified by extracting a vibration component of a cycle corresponding to two rotations of the first motor.

According to an embodiment, an amplitude of the compensation torque may be identified based on a torque map previously set according to the RPM of the driving shaft.

According to an embodiment, a phase of the compensation torque may be identified by substituting the RPM of the driving shaft into an adaptive filter.

According to an embodiment, the method may further include identifying the phase of the compensation torque again when the vibration identified after controlling the output torque has a greater magnitude than a preset reference vibration.

According to an embodiment, the compensation torque may be identified in a sinusoidal waveform.

According to an embodiment, the final compensation torque may be identified as torque that has an amplitude obtained by subtracting the charging torque from the maximum torque, and has the same phase as the compensation torque.

According to an embodiment of the disclosure, there are provided a hybrid electric vehicle, in which vibration and noise due to the exciting force of an engine are reduced, and a method of controlling the same.

Further, there are provided a hybrid electric vehicle, in which vibration in a low frequency band due to torque imbalance is effectively reduced in the process of reducing vibration and noise, and a method of controlling the same.

Further, the disclosure is to provide a hybrid electric vehicle, in which reduction in charging torque is minimized in the process of reducing vibration and noise, and a method of controlling the same.

It should be noted that effects of the disclosure are not limited to those described above and other effects of the disclosure will be apparent to those skilled in the art from the following description.

### BRIEF DESCRIPTION OF THE FIGURES

FIG. 1 is a diagram for describing the generation and transmission path of vibration in a hybrid electric vehicle according to an embodiment.

FIG. 2 illustrates a configuration of a powertrain in a hybrid electric vehicle according to an embodiment of the disclosure.

FIG. 3 illustrates a configuration of a control system in a hybrid electric vehicle according to an embodiment of the disclosure.

FIG. 4 is a graph for describing engine vibration and compensation torque according to an embodiment of the disclosure.

FIGS. 5A, 5B, and 5C are graphs showing charging torque, compensation torque and sum torque according to an embodiment of the disclosure.

FIG. 6 shows torque output from an engine and a first motor during compensation torque control according to an embodiment of the disclosure.

FIGS. 7 and 8 are graphs for describing the revolution per minute (RPM) change and low-frequency vibration of an engine during compensation torque control according to an embodiment of the disclosure.

FIG. 9 is a graph for describing compensation torque and final compensation torque according to an embodiment of the disclosure.

FIG. 10 is a flowchart for describing control of a controller that identifies final compensation torque and reduces vibration according to an embodiment of the disclosure.

FIG. 11 is a graph showing vibration components measured in a hybrid electric vehicle according to an embodiment of the disclosure.

### DETAILED DESCRIPTION

Hereinafter, embodiments of the disclosure will be described in detail with reference to the accompanying drawings, in which the same or similar elements are denoted by the same reference numerals even though they are depicted in different drawings and redundant descriptions thereof will be avoided. Suffixes “module” and “unit” put after components in the following description are given in consideration of only ease of description and do not have meaning or functions discriminated from each other. Further, in terms of describing the embodiments of the disclosure, detailed descriptions of related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents and substitutions within the scope and spirit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

Further, Further, terms “unit” or “control unit” forming part of the names of a motor control unit (MCU), a hybrid control unit (HCU), etc., are merely terms that are widely used in the naming of a controller for controlling a specific function of a vehicle, and should not be construed as meaning a generic function unit. For example, each control unit may include a communication device that communicates with other control units or sensors, in order to control its own functions, a memory that stores an operating system, logic commands, and input/output information, and one or more processors that perform determination, calculation, decision, and the like, which is necessary for the control of the function that is responsible therefor.

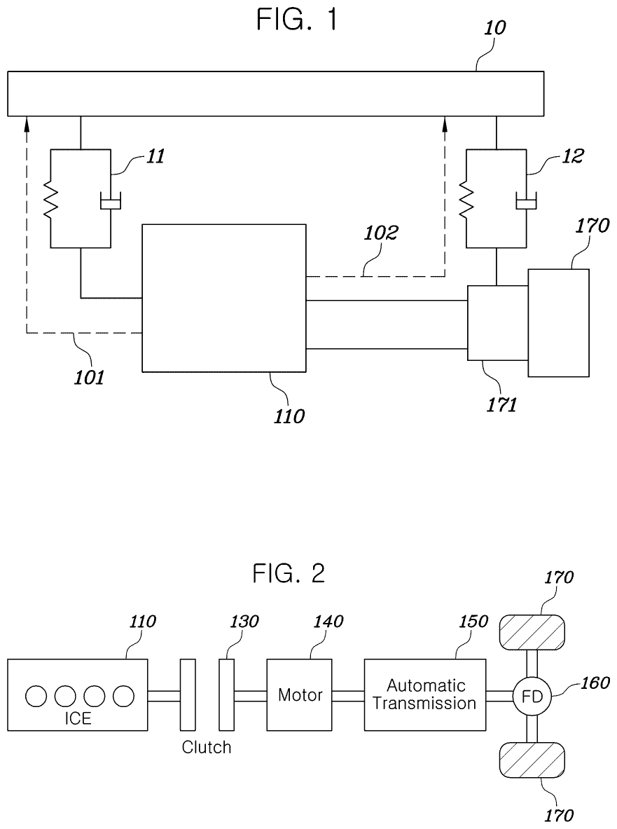

FIG. 1 is a diagram for describing the generation and transmission path of vibration in a hybrid electric vehicle according to an embodiment.

Referring to FIG. 1, the vibration generated in an engine 110 may be transmitted to a vehicle body 10 through various paths.

Specifically, the vibration generated in the engine 110 may be transmitted directly to the vehicle body 10 through a PT mount 11 connected to the engine 110.

Here, a path through which the vibration is transmitted from the engine 110 to the vehicle body 10 via the PT mount 11 will be defined as a first path 101.

The vibration generated in the engine 110 may be transmitted to the vehicle body 10 via a configuration of a powertrain connected to the engine 110, a heel hub 171 connected to a wheel 170, a corner module 12, etc.

Here, the corner module 12 refers to a device for connection between the vehicle body 10 and the wheel hub 171, and may include, for example, a suspension, a suspension arm, etc.

Here, a path through which the vibration is transmitted to the vehicle body 10 via the configuration of the powertrain connected to the engine 110, and the corner module 12 will be defined as a second path 102.

In a general hybrid electric vehicle in which a starting power generation motor is connected to the engine through a belt and a pulley, it is difficult to reduce the vibration in both the first path 101 and the second path 102. For example, when the engine 110 and the starting power generation motor are connected by the pulley and the belt, etc., the slip or the like of the belt may cause a structural disadvantage in detecting the vibration of the engine 110 through the starting power generation motor and controlling the output of compensation torque, thereby making it difficult to reduce the vibration for the first path 101.

Further, when a driving motor is used to reduce vibration, a damper or clutch such as a dual mass flywheel (DMF) is located between the driving motor and the engine, and it is thus substantially impossible to reduce the vibration for the second path 102.

Therefore, according to embodiments of the disclosure, a hybrid electric vehicle with a powertrain, in which a motor serving as the starting power generation motor is directly connected to the engine, will be assumed.

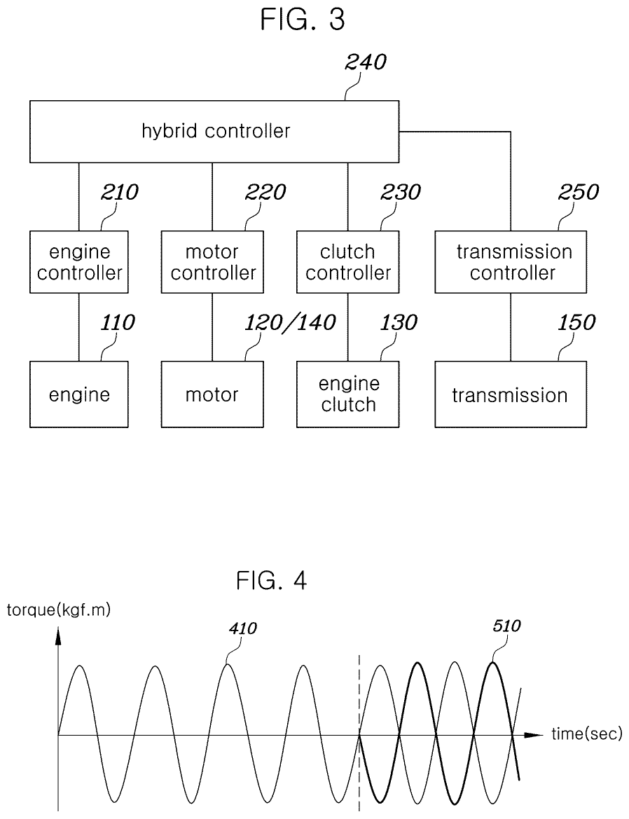

FIG. 2 illustrates a configuration of a powertrain in a hybrid electric vehicle according to an embodiment of the disclosure.

Referring to FIG. 2, the powertrain of the hybrid electric vehicle employs a parallel type hybrid system in which two motors 120 and 140 and an engine clutch 130 are mounted between an internal combustion engine (ICE) 110 and a transmission 150. Such a parallel type hybrid system may also be called a transmission mounted electric drive (TMED) hybrid system because the motor 140 is always connected to an input terminal of the transmission 150.

Here, a first motor 120 between the two motor 120 and 140 is placed between the engine 110 and a first end of the engine clutch 130, and an engine shaft of the engine 110 and a first motor shaft of the first motor 120 are directly connected to each other and always rotated together.

A second motor shaft of the second motor 140 has a first end connected to a second end of the engine clutch 130, and a second end connected to the input terminal of the transmission 150.

The second motor 140 may have a greater power output than the first motor 120, and serve as a driving motor. Further, the first motor 120 may function as a starting motor that cranks the engine 110 when the engine 110 is started, may recover the rotational energy of the engine 110 by power generation when the engine is off, and may generate power with the power of the engine 110 while the engine 110 is operating.

In the hybrid electric vehicle (HEV) including the powertrain as shown in FIG. 2, when a driver depresses an accelerator pedal after starting the vehicle (e.g., HEV Ready), the second motor 140 is first driven with power from a battery (not shown) while the engine clutch 130 is being open. The power from the second motor 140 is then transmitted to wheels 170 via a transmission 150 and a final drive (FD) 160, thereby causing the wheel 170 to move (i.e., an electric vehicle (EV) mode). As the vehicle gradually accelerates and requires a larger driving force, the first motor 120 may operate to crank the engine 110.

After the engine 110 is started, the engine clutch 130 is engaged when difference in rotational speed between the engine 110 and the second motor 140 falls within a specific range, thereby causing the engine 110 and the second motor 140 to rotate together (i.e., transition from the EV mode to an HEV mode). Then, the output of the second motor 140 is decreased and the output of the engine 110 is increased by a torque blending process, thereby satisfying a driver's required torque. In the HEV mode, the required torque may be satisfied by the engine 110, and the difference between the engine torque and the required torque may be compensated by at least one of the first motor 120 and the second motor 140. For example, when the engine 110 outputs a torque higher than the required torque in consideration of the efficiency of the engine 110, the first motor 120 or the second motor 140 may perform power generation as much as a surplus engine torque. On the other hand, when the engine torque is lower than the required torque, at least one of the first motor 120 and the second motor 140 may output a torque as much as insufficiency.

When a preset engine-off condition is satisfied due to the deceleration or the like of the vehicle, the engine clutch 130 is opened and the engine 110 is stopped (i.e., transition from the HEV mode to the EV mode). During the deceleration, the battery is charged with the driving force of the wheels by the second motor 140, which is called braking energy recovery or regenerative braking.

In general, the transmission 150 may include a stepped transmission, or a multi-plate clutch, for example, a dual clutch transmission (DCT).

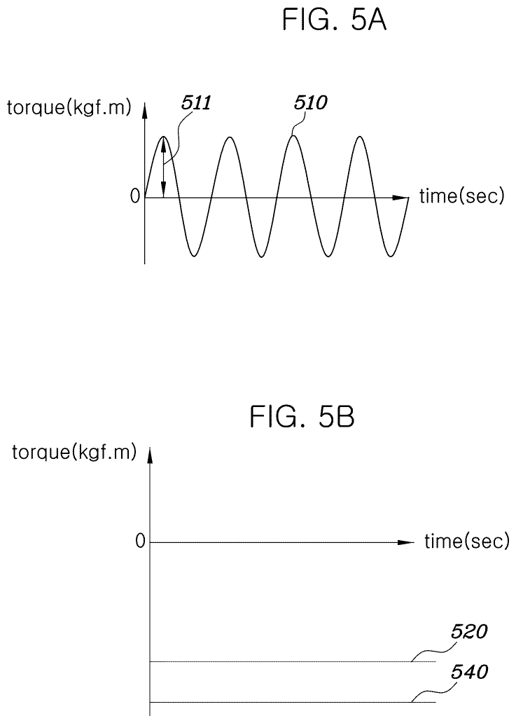

FIG. 3 illustrates a configuration of a control system in a hybrid electric vehicle according to an embodiment of the disclosure.

Referring to FIG. 3, in the hybrid electric vehicle to which embodiments of the disclosure is applicable, the internal combustion engine 110 may be controlled by an engine control unit (engine controller) 210, the torque of the first motor 120 and the torque of the second motor 140 may be controlled by a motor control unit (MCU) or motor controller 220, and the engine clutch 130 may be controlled by a clutch control unit 230, respectively. Here, the engine control unit 210 is also referred to as an engine management system (EMS). Further, the transmission 150 is controlled by a transmission control unit 250.

The motor control unit 220 may control a gate drive unit (not shown) with a pulse width modulation (PWM) control signal based on a motor angle, a phase voltage, a phase current, a required torque, etc. of each of the motors 120 and 140, and the gate drive unit may control an inverter (not shown) for driving each of the motors 120 and 140 based on the control signal.

Each control unit is connected to its high-level control unit, i.e., a hybrid control unit (HCU) 240, which controls the powertrain overall including a mode switching process, and may provide information, which is necessary for controlling the engine clutch when changing the driving mode or shifting gears and/or controlling the engine to stop, to the hybrid control unit 240, or perform an operation based on the control signal, under the control of the hybrid control unit 240.

For example, the hybrid control unit 240 identifies whether to perform switching between EV-HEV modes or between CD-CS modes (in the case of a PHEV) based on the operating state of the vehicle. To this end, the hybrid control unit 240 identifies timing to open the engine clutch 130 and performs hydraulic control at that timing. Further, the hybrid control unit 240 identifies the states (lock-up, slip, open, etc.) of the engine clutch 130 and controls timing to stop the fuel injection of the engine 110. In addition, the hybrid control unit 240 may transmit a torque command for controlling the torque of the first motor 120 to the motor control unit 220 to control the engine stop, thereby controlling the rotational energy recovery of the engine. Further, the hybrid control unit 240 may identify the states of each of the drive sources 110, 120, and 140 to satisfy the required torque, and identify the required driving forces to be shared among the drive sources 110, 120, 140 based on the identified states, thereby transmitting the torque command to the control units 210 and 220 for controlling the drive sources.

Of course, it will be apparent to those skilled in the art that the foregoing connections between the control units and the foregoing functions/divisions of the control units are merely exemplary and not limited to their naming. For example, the hybrid control unit 240 may be replaced by any one of the other control units, or its functions may be distributively provided by two or more of the other control units.

The foregoing configurations shown in FIGS. 2 and 3 are merely examples of the hybrid electric vehicle, and it will be obvious to those skilled in the art that the hybrid electric vehicle applicable to the embodiments is not limited to such a structure.

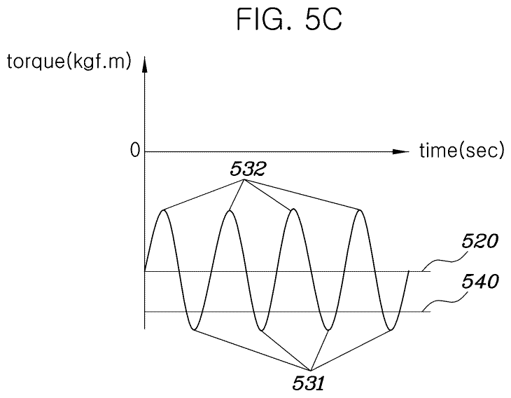

FIG. 4 is a graph for describing engine vibration and compensation torque according to an embodiment of the disclosure.

Referring to FIG. 4, the graph shows a relationship between exciting force torque (hereinafter referred to as ‘vibration’) 410 and compensation torque 510 due to the vibration of the engine 110. In the graph of FIG. 4, the horizontal axis represents time, and the vertical axis represents amplitude.

The vibration 410 of the engine 110 may be caused by an explosion in a combustion chamber during a driving process. For example, during stationary charging, the engine clutch 130 is kept open and the engine 110 is controlled to maintain a preset revolution per minute (RPM). In this case, the explosion in the combustion chamber may periodically generate the vibration 410 of the engine 110, and the vibration 410 of the engine 110 may cause the rotation frequency of the engine 110 to tremble.

To reduce the vibration 410, the first motor 120 may output the compensation torque 510 that has a reverse phase to the vibration 410.

For example, the motor controller 220 controls the torque output from the first motor 110 directly connected to the engine 110 based on the compensation torque 510 identified by the hybrid control unit 240, thereby cancelling out the vibration 410 of the engine 110.

Hereinafter, the process of the motor controller 220 to control the torque output from the first motor 120 based on the compensation torque 510 or sum torque of the charging torque for charging the battery during the stationary charging and the compensation torque 510 will be referred to as ‘compensation torque control.’

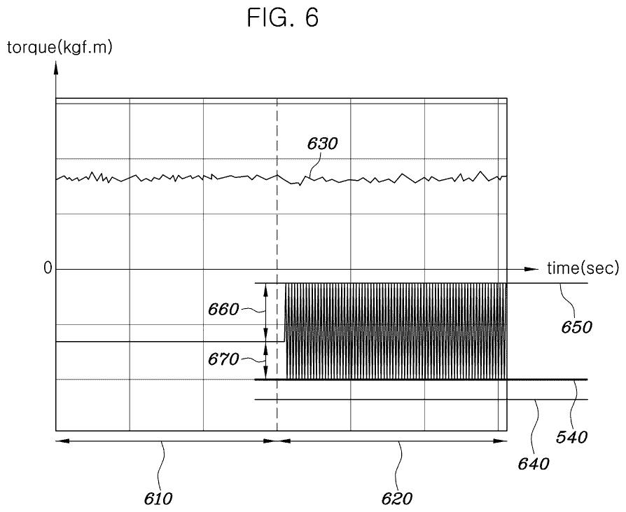

FIGS. 5A-5C are graphs showing the charging torque, the compensation torque, and the sum torque according to an embodiment of the disclosure.

Referring to FIGS. 5A-5C, the compensation torque 510 is shown at the top, the charging torque 520 is shown in the middle, and the sum torque 530 of the charging torque and the compensation torque is shown at the bottom.

The motor controller 220 may control the first motor 120 to output the compensation torque 510 to reduce the vibration 410 during the stationary charging.

Here, the compensation torque 510 may correspond to a sinusoidal waveform that has a constant compensation torque amplitude 511.

Further, during the stationary charging, the motor controller 220 may control the first motor 120 to output the charging torque 520 for charging the battery. Here, the charging torque 520 may be previously set considering the operating point of the engine 110 during the stationary charging.

In this case, the motor controller 220 may receive the sum torque 530, which is the sum of the compensation torque 510 identified by the hybrid control unit 240 and the charging torque 520, and control the output torque of the first motor 120 based on the sum torque 530.

Here, a first section 531 may refer to a section where the absolute value of the sum torque 530 is greater than the charging torque 520, and a second section 532 may refer to a section where the absolute value is smaller than the charging torque 520.

Further, when the absolute value of the sum torque 530 identified by the hybrid control unit 240 is greater than the absolute value of the preset maximum torque 540 of the first motor 120, the torque output from the first motor 120 may be limited to the maximum torque 540.

Here, the maximum torque 540 of the first motor 120 may refer to the maximum torque, which can be currently output within nominal maximum torque of the first motor 120, in consideration of the states (e.g., overtemperature, state of charge (SoC) level, etc.) of the battery, the overtemperature of the first motor 120 or the inverter that controls the first motor 120, etc.

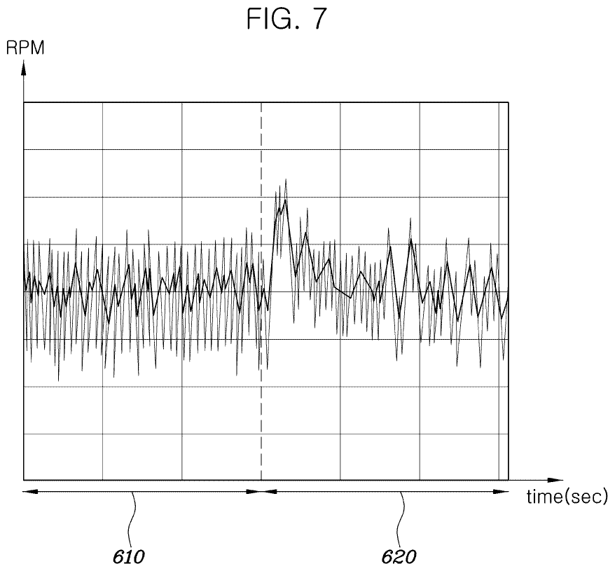

FIG. 6 shows torque output from the engine and the first motor when controlling the compensation torque according to an embodiment of the disclosure.

Referring to FIG. 6, engine torque 630 and the output torque of the first motor 120 are shown in each of a section 610 before the compensation torque control and a section 620 after the compensation torque control.

In the section 610 before the compensation torque control, the first motor 120 outputs the charging torque 520 for charging the battery based on the engine torque 630.

Here, the charging torque 520 may correspond to negative (−) torque, the phase of which is opposite to that of the torque 630 of the engine 110, based on the torque 630 of the engine 110 having positive (+) torque.

Below, the output torque generated by the first motor 120 will be assumed as the negative (−) torque, and therefore comparison in the amplitude of the torque is based on the absolute value unless otherwise specified. For example, the description that ‘the sum torque 530 identified by the hybrid control unit 240 may be greater than the maximum torque 540 of the first motor 120’ means that ‘the absolute value of the sum torque 530 may exceed the absolute value of the preset maximum torque 540 of the first motor 120,’ and ‘the maximum value of the torque’ may mean ‘the maximum absolute value of the torque.’In the section 620 after the compensation torque control, the hybrid control unit 240 may transmit a torque command, which corresponds to the sum torque 530 based on the sum of the compensation torque 510 and the charging torque 520, to the motor controller 220, and the motor controller 220 may control the first motor 120 based on the sum torque 530 based on the received torque command.

However, when the sum torque 530 identified by the hybrid control unit 240 exceeds the maximum torque 540 of the first motor 120, the torque actually output from the first motor 120 may not exceed the maximum torque 540 of the first motor 120.

Specifically, when the sum torque 530 exceeds the maximum torque 540 of the first motor 120, the torque of the second section 532 of the sum torque 530 may be output similarly to the identified sum torque 530, but the torque exceeding the maximum torque 540 within the torque of the first section 531 may not be output from the first motor 120.

Therefore, in the section where the sum torque 530 exceeds the maximum torque 540, the maximum torque 540, rather than the identified torque value, may be output as the first motor 120.

In other words, in the second section 532, the torque of which the maximum value is a value 660 obtained by subtracting the charging torque 520 from a second reference torque 650 is output, but in the first section 531, the torque of which the maximum value is not the value obtained by subtracting the charging torque 520 from a first reference torque 640 but a value 670 obtained by subtracting the charging torque 520 from the maximum torque 540.

In this case, due to imbalance between the torque of the first section 531 and the torque of the second section 532 output from the first motor 120, vibration components may be generated in a specific low frequency band.

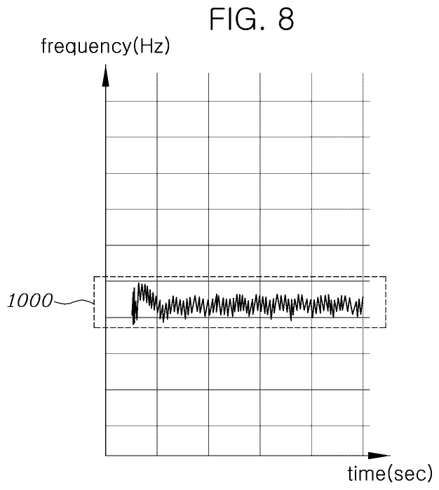

FIGS. 7 and 8 are graphs for describing the RPM change and low-frequency vibration of the engine during compensation torque control according to an embodiment of the disclosure.

Referring to FIG. 7, the RPM change of the engine 110 is shown in the RPM graph of the engine 110, in which the horizontal axis represents time, and the vertical axis represents the RPM.

In the section 610 before the compensation torque control, the RPM of the engine 110 has a relatively large fluctuation range due to the vibration 410 of the engine 110 compared to that in the section 620 after the compensation torque control.

In the section 620 after the compensation torque control, the fluctuation range of the RPM due to the vibration 410 of the engine 110 is relatively reduced compared to that in the section 610 before applying the compensation torque.

However, the fluctuation of the RPM in the section 620 after the compensation torque control is as follows. The fluctuation range of the RPM is decreased, but an RPM tremble of the engine 110 occurs at a certain period. To describe the RPM tremble of the engine 110 in more detail, the vibration 410 during the compensation torque control is represented in the frequency domain as shown in FIG. 8.

FIG. 8 shows the frequency of the vibration detected in the hybrid electric vehicle during the compensation torque control.

When a target RPM for the stationary charging is 1,350, the engine 110 rotates about 23 times per second, and, in the case of a 4-cylinder engine, two explosions occur per rotation, and the compensation torque for each explosion is subject once to the maximum torque limit of the first motor 120. Ultimately, the maximum torque limit causes the vibration to occur in a low frequency range of 40 to 50 Hz due to waveform imbalance between the phases of the compensation torque. As shown in FIG. 8, a certain vibration occurs in such a low-frequency band 1000.

Referring to FIGS. 7 and 8 comprehensively, when the compensation torque is controlled, the fluctuation range of the RPM due to the vibration 410 of the engine 110 may be reduced, but vibration corresponding to torque exceeding the maximum torque 540 in the first section 531 is not reduced, thereby causing the low-frequency vibration to occur.

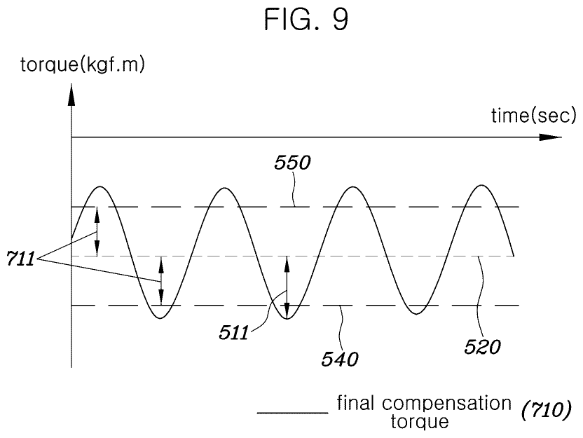

FIG. 9 is a graph for describing compensation torque and final compensation torque according to an embodiment of the disclosure.

Referring to FIG. 9, the compensation torque 510 and the final compensation torque 710, which is obtained by limiting both the maximum and minimum values of the compensation torque 510, are shown.

When the sum of the amplitude 511 of the compensation torque 510 and the charging torque 520 exceeds the maximum torque 540, the hybrid control unit 240 may transmit a command for the final compensation torque 710, which limits the absolute value of the compensation torque 510 not to exceed the value obtained by subtracting the charging torque 520 from the maximum torque 540, to the motor controller 220.

In this case, the maximum change 711 in the final compensation torque 710 based on the charging torque 520 may correspond to the value obtained by subtracting the charging torque 520 from the maximum the torque 540.

In the final compensation torque 710, the torque smaller than the maximum torque 540, which is obtained by adding the maximum change 711 of the final compensation torque 710 to the charging torque 520, within the torque of the first section 531 of the compensation torque 510 may be included as it is, but the torque greater than the maximum torque 540 may be limited to the maximum torque 540.

As in the case of the first section 531, in the final compensation torque 710, the torque greater than the minimum torque 550, which is obtained by subtracting the maximum change 711 of the final compensation torque 710 from the charging torque 520, within the torque of the second section 532 of the compensation torque 510 may be included as it is, but the torque smaller than the minimum torque 550 may be limited to the minimum torque 550.

In other words, the final compensation torque 710 may be identified by limiting the magnitude of the torque exceeding the maximum change 711 of the final compensation torque 710 within the compensation torque 510 to the maximum change 711 of the final compensation torque 710.

When the output of the first motor 120 is controlled based on the sum torque of the compensation torque 510 and the charging torque 520, only the torque of the first component 531 is limited and thus there is an imbalance between the torque of the first component 531 and the torque of the second component 532.

In this case, the vibration may occur due to the imbalance between the torque of the first component 531 and the torque of the second component 532, and the amount of power charged to the battery may be reduced because the average of the output torque is smaller than the charging torque 520.

On the other hand, when the output of the first motor is controlled based on the sum torque of the final compensation torque 710 and the charging torque 510, the torque of the first component 531 and the torque of the second component 532 are all limited, thereby resolving the imbalance between the torque of the first component 531 and the torque of the second component 532.

In this case, the vibration due to the imbalance between the torque of the first component 531 and the torque of the second component 532 may be reduced, and the amount of power charged to the battery may not be reduced because the average of the output torque corresponds to the charging torque 520.

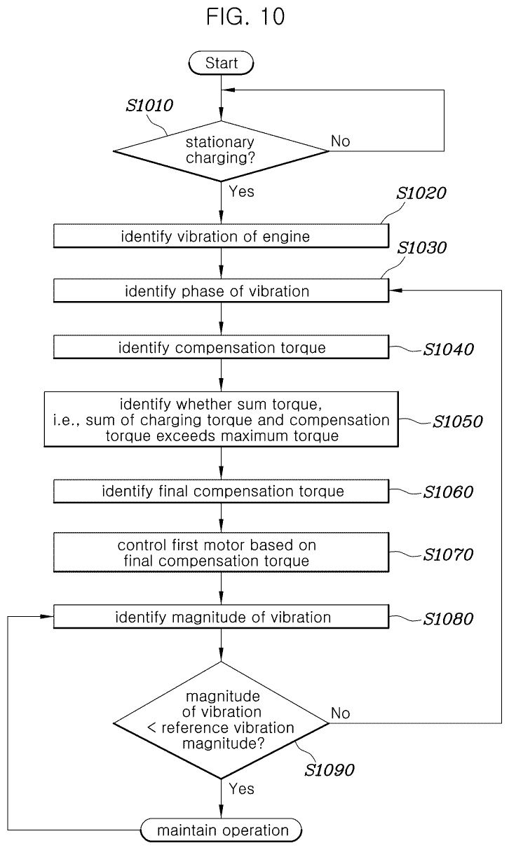

FIG. 10 is a flowchart for describing control of the controller that identifies the final compensation torque and reduces the vibration according to an embodiment of the disclosure.

Referring to FIG. 10, the hybrid control unit 240 identifies whether the stationary charging is performed (S1010), and identifies the vibration 410 of the engine 110 (S1020) when it is identified that the stationary charging is performed (Yes in S1010).

Here, the hybrid control unit 240 may identify the vibration 410 of the engine 110 by extracting a vibration component of a cycle corresponding to two rotations of the first motor 210. In this case, the extracted vibration 410 may correspond to vibration caused by the exciting force of the engine 110.

Further, the hybrid control unit 240 may identify the phase of the identified vibration 410 (S1030). Here, the hybrid control unit 240 may identify the phase of the compensation torque 510 by substituting the RPM of a driving shaft of the first motor 120 into an adaptive filter.

Further, the hybrid control unit 240 may identify the magnitude of the vibration 410 and identify the compensation torque 510 based on the identified magnitude and phase of the vibration 410 (S1040).

Here, the hybrid control unit 240 may identify the compensation torque 510 as a value that has the reverse phase to the vibration 410 and periodically repeats increase and decrease with a constant amplitude.

Specifically, the hybrid control unit 240 may identify the amplitude of the compensation torque 510 based on a torque map previously set according to the RPM of the driving shaft of the first motor 120.

In this case, the hybrid control unit 240 may identify the compensation torque 510 in the form of a sinusoidal wave. For example, the hybrid control unit 240 may identify the phase of the compensation torque 510 based on the phase of the vibration 410, and identify the amplitude 511 of the compensation torque 510 based on the RPM of the driving shaft of the first motor 120, thereby identifying the compensation torque 510 in the form of the sinusoidal wave.

However, the hybrid control unit 240 does not necessarily have to identify the entire waveform function of the compensation torque 510. For example, the hybrid control unit 240 identifies the compensation torque 510 that has the reverse phase to the vibration 410 identified in real time and is based on the magnitude of the torque identified based on the RPM of the driving shaft of the first motor 120, and the identified compensation torque 510 may correspond to a sinusoidal wave that has the reverse phase to the vibration 410 and a constant compensation torque amplitude 511.

Further, the hybrid control unit 240 may identify whether the sum torque 530, which is the sum of the charging torque 520 and the compensation torque 510, exceeds the maximum torque 540 (S1050), identify the final compensation torque 710 based on the compensation torque 510 (S1060), and control the output torque of the first motor 120 based on the identified final compensation torque 710 (S1070).

Here, when the amplitude 511 of the compensation torque 540 is greater than the maximum change 711 of the final compensation torque 710, the hybrid control unit 240 may limit the magnitude of the torque in an exceeding section to the maximum change 711, thereby identifying the final compensation torque 710.

For example, the hybrid control unit 240 may identify the final compensation torque 710 as the maximum change 711 of the final compensation torque 710 in a section where the magnitude of the compensation torque 510 exceeds the maximum change 711 of the final compensation torque 710, and identify the final compensation torque 710 as the same value as the compensation torque 510 in a section where the magnitude of the compensation torque 510 does not exceed the maximum change 711 of the final compensation torque 710.

In this case, the identified final compensation torque 710 has the same phase as the compensation torque 510 in the form of the sinusoidal wave, of which the upper and lower limits are clipped.

However, the final compensation torque 710 is not limited to the sinusoidal waveform of which the upper and lower limits are clipped.

For example, the hybrid control unit 240 may identify the final compensation torque 710, which has the maximum change 711 as the value obtained by subtracting the charging torque 520 from the maximum torque 540, and has the same phase as the compensation torque 510 in the form of a sinusoidal waveform.

According to an alternative example, when the sum of the charging torque 520 and the amplitude 511 of the compensation torque is smaller than the maximum torque 540 of the first motor 120, the final compensation torque 710 may be identified in the same form as the compensation torque 510.

After controlling the output torque (S1070), the hybrid control unit 240 may identify the magnitude of the vibration 410, and identify the phase of the compensation torque again (S1030) when the magnitude of the vibration 410 identified again is greater than that of a preset reference vibration (Yes in S1090).

When the magnitude of the vibration 410 identified again is smaller than that of the preset reference vibration (No in S1090), the hybrid control unit 240 may repeat the process of identifying the vibration 410 of the engine 110 (S1080) and identifying whether the magnitude of the vibration 410 exceeds that of the preset reference vibration (S1090), thereby monitoring whether the vibration 410 is reduced.

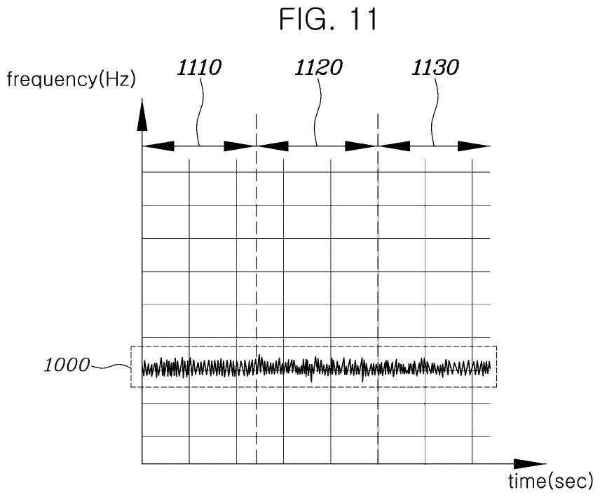

FIG. 11 is a graph showing vibration components measured in a hybrid electric vehicle according to an embodiment of the disclosure.

FIG. 11 shows the vibration 410 measured under the condition that the hybrid control unit 240 controls the first motor 120 based on only the charging torque 520 in a first section 1010, controls the first motor 120 based on the sum torque 530, which is the sum of the compensation torque 510 and the charging torque 520, in a second section 1020, and controls the first motor 120 based on the sum of the charging torque 520 and the final compensation torque 710 in a third section 1030.

In the first section 1010, the magnitude of the vibration 410 in the low-frequency band 1000 corresponding to the vibration 410 caused by the exciting force of the engine 110 is the largest compared to those in other sections.

In the second section 1020, the magnitude of the vibration 410 in the low-frequency band 1000 is small compared to those in other sections but a frequency tremble occurs in the low-frequency band 1000.

In the third section 1030, the magnitude of the vibration 410 is reduced compared to that in the first section 1010, and the frequency tremble is reduced in the low-frequency band 1000 compared to that in the second section 1020.

Therefore, referring to FIG. 11 comprehensively, the hybrid control unit 240 controls the output torque of the first motor 120 based on the sum of the charging torque 520 and the final compensation torque 710, thereby reducing the vibration 410 in the low-frequency band 1000 and preventing a frequency tremble.

Meanwhile, the disclosure may be implemented as a computer-readable code on a medium where a program is recorded. The computer-readable medium includes any types of recording devices that store data that may be read by a computer system. For example, the computer-readable medium includes a hard disk drive (HDD), a solid-state disk (SSD), a silicon disk drive (SDD), a read only memory (ROM), a random-access memory (RAM), a compact disc (CD)-ROM, a magnetic tape, a floppy disk, an optical data storage device, and the like. Therefore, the foregoing detailed description should not be construed as limiting in all respects and should be considered for illustrative purposes. The scope of the disclosure should be identified by reasonable interpretation of the appended claims, and any change within the equivalent scope of the disclosure is included in the scope of the disclosure.

1. A hybrid electric vehicle comprising:
an engine;
a first motor comprising a driving shaft connected directly to the engine; and
a controller configured to:
determine vibration of the engine through the first motor in a mode where the first motor performs charging with power of the engine;
determine compensation torque, which periodically increases and decreases to have a reverse phase to the vibration;
determine final compensation torque, in which an absolute value of the compensation torque is limited and does not exceed a value obtained by subtracting a changing torque of the first motor from a maximum torque of the first motor, when a sum of a maximum amplitude of the compensation torque and a magnitude of the charging torque exceeds the maximum torque of the first motor; and
control an output torque of the first motor based on a sum of the final compensation torque and the charging torque.

2. The hybrid electric vehicle of claim 1, wherein the controller is configured to determine the vibration by extracting a vibration component of a cycle corresponding to two rotations of the first motor.

3. The hybrid electric vehicle of claim 1, wherein an amplitude of the compensation torque is determined based on a torque map previously set according to revolutions per minute (RPM) of the driving shaft.

4. The hybrid electric vehicle of claim 1, wherein a phase of the compensation torque is determined by substituting RPM of the driving shaft into an adaptive filter.

5. The hybrid electric vehicle of claim 4, wherein the controller is configured to determine the phase of the compensation torque again when the vibration determined after controlling the output torque has a greater magnitude than a preset reference vibration.

6. The hybrid electric vehicle of claim 1, wherein the controller is configured to determine the compensation torque in a sinusoidal waveform.

7. The hybrid electric vehicle of claim 1, further comprising:
a second motor connected directly to an input terminal of a transmission; and
an engine clutch configured to selectively connect the first motor and the second motor.

8. A hybrid electric vehicle comprising:
an engine;
a first motor comprising a driving shaft connected directly to the engine; and
a controller configured to:
determine vibration of the engine through the first motor in a mode where the first motor performs charging with power of the engine;
determine compensation torque, which periodically increases and decreases to have a reverse phase to the vibration;
limit maximum and minimum values of the compensation torque to a first value, and a second value being opposite to the first value, when a sum of a maximum amplitude of the compensation torque and a charging torque exceeds a maximum torque of the first motor; and
control an output torque of the first motor based on a sum of the compensation torque and the charging torque;
wherein the first value corresponds to a value obtained by subtracting the changing torque from the maximum torque.

9. A method of controlling a hybrid electric vehicle, comprising:
determining, by a controller, vibration of an engine, which is directly connected to a driving shaft of a first motor, through the first motor;
determining compensation torque, which periodically increases and decreases to have a reverse phase to the vibration;
determining a final compensation torque, in which an absolute value of the compensation torque is limited and does not exceed a value obtained by subtracting a changing torque of the first motor from a maximum torque of the first motor when a sum of a maximum amplitude of the compensation torque and a magnitude of charging torque exceeds a maximum torque of the first motor; and
controlling an output torque of the first motor based on a sum of the final compensation torque and the charging torque.

10. The method of claim 9, wherein the vibration is determined by extracting a vibration component of a cycle corresponding to two rotations of the first motor.

11. The method of claim 9, wherein an amplitude of the compensation torque is determined based on a torque map previously set according to revolutions per minute (RPM) of the driving shaft.

12. The method of claim 9, wherein a phase of the compensation torque is determined by substituting RPM of the driving shaft into an adaptive filter.

13. The method of claim 12, further comprising determining the phase of the compensation torque again when a magnitude of the vibration determined after controlling the output torque is greater than a preset reference vibration magnitude.

14. The method of claim 9, wherein the compensation torque is determined in a sinusoidal waveform.

15. The method of claim 9, wherein the final compensation torque is determined as torque that has an amplitude obtained by subtracting the charging torque from the maximum torque, and has the same phase as the compensation torque.
